(19) United States
(12) Patent Application Publication
(10) Pub. No.: US 2009/0274841 A1
(43) Pub. Date: Nov. 5, 2009

(54) PROCESS FOR COATING AND CLEANING METAL SURFACES

(75) Inventor: Joseph Mihelic, Sparta, NJ (US)

Correspondence Address: David L. Hedden;Ashland Inc., P.O. Box 2219, Columbus, OH, 43216, US

(73) Assignee: Ashland Licensing and Intellectual Property LLC.

(21) Appl. No.: 12/498,571

(22) Filed: Jul. 7, 2009

Related U.S. Application Data
(63) Continuation of application No. 11/596,446, filed on Nov. 13, 2006, now abandoned.
(60) Provisional application No. 60/572,019, filed on May 18, 2004.

(51) Int. Cl. B05D 3/00

(52) U.S. Cl. 427/354; 427/353

(57) ABSTRACT

This invention relates to process for coating a metal surface, wherein said process comprises contacting the metal surface with a barrier coating comprising (a) an amine salt of a fatty acid or an amine salt of a derivative of a fatty acid, (b) a salt of a non polymeric aromatic acid, (c) optionally, a nonionic or anionic surfactant, and (d) water. The invention further comprises a process for cleaning a metal surface containing residues, which comprises contacting the metal surface, exposed to the barrier coating, with water to remove residues that have deposited after applying the barrier coating to the metal surface.

### FIELD OF THE INVENTION

This invention relates to process for coating a metal surface, wherein said process comprises contacting the metal surface with a barrier coating comprising (a) an amine salt of a fatty acid or an amine salt of a derivative of a fatty acid, (b) a salt of a non polymeric aromatic acid, (c) optionally, a nonionic or anionic surfactant, and (d) water. The invention further comprises a process for cleaning a metal surface containing residues, which comprises contacting the metal surface, exposed to the barrier coating, with water to remove residues that have deposited after applying the barrier coating to the metal surface.

### BACKGROUND OF THE INVENTION

Residues such as cement, iron ore, sulfur, coal and petroleum coke often develop on metal surfaces and have to be removed. This is particular a problem in the container and cargo industry.

It is known that such residues can be removed from metal surfaces by the application of corrosive solvents, e.g. mineral acids. It also known to apply barrier agents to the metal surface once it has been cleaned in order to keep from residues from being deposited again. Some of the well-known barrier aids are a soya-based barrier aid sold by RoBo Products/RBM, Stomme and a silicone-based barrier aid sold by Dow Corning. One of the problems with using these barrier aids is that they require supplemental products to remove them after they are applied.

U.S. Pat. No. 6,458,320 relates to a corrosion inhibitor for galvanized steel comprising (a) an amine salt of a fatty acid or an amine salt of a derivative of a fatty acid, (b) preferably a salt of a non polymeric aromatic acid, and (c) preferably a nonionic or anionic surfactant, and water, but not as a barrier coating composition, or as part of a barrier coating process. The patent does not teach or suggest that the composition can be used as a coating that enables one to remove residues such as cement, which has deposited on a metal surface.

All citations to prior art are incorporated by reference.

### SUMMARY OF THE INVENTION

This invention relates to process for coating a metal surface, wherein said process comprises contacting a metal surface with a barrier coating comprising:
(a) an amine salt of a fatty acid or an amine salt of a derivative of a fatty acid;
(b) a salt of a non polymeric aromatic acid;
(c) optionally, a nonionic or anionic surfactant having an HLB of 1 to 20; and
(d) water.

The barrier coating can be applied to any metal surface, but is particularly useful for steel surfaces, most particularly for carbon steel. Preferably the metal surface should be clean or substantially clean of residues such as cement, iron ore, sulfur, coal, and petroleum coke when the barrier coating is applied. It is believed that the barrier coating will be effective when applied to metal surfaces that are painted or otherwise coated.

One of the advantages of the process is that residue that forms after the barrier coating is applied can removed by washing with water. Thus, another aspect of the invention relates to washing residues from the metal surface with water after the barrier coating is applied to the metal surface. The barrier coating is allowed to become tacky or dry before loading the cargo. Typically, a waiting period of at least two hours is required before loading the cargo. Residues of the cargo then loaded can be removed by water after the cargo is unloaded. The thickness of the barrier coating ranges from 0.5 mils to 5.0 mils., typically 0.8 mils to 3.0 mils.

The barrier coating can be applied in such a manner to obtain a reproducible thickness. It can be applied by brushing, spraying, or other means.

A particularly useful application of the process relates to the removal of residues form larger bulk cargoes. Residues that accumulate on these containers and vessels include powders and dusts, e.g. dusts from larger bulk cargoes, such as dust form iron ore pellets. The thickness of the residue can be several inches, but the residue can still be removed with washing if the barrier coating has been applied to the metal surface containing the bulk cargo. When the residue is thicker, i.e. an inch or more, it may be necessary to use a high-pressure water jet to create sufficient force to remove the residue from the surface.

### DETAILED DESCRIPTION OF THE INVENTION

The amine salts of fatty acids or the amine salts of derivatives of fatty acids used in the barrier coating are formed by neutralizing a carboxylic acid with an amine. The carboxylic acid used may be a saturated or unsaturated, mono-, di-, or polycarboxylic acid having a least six carbon atoms per functional group. Specific examples include, but are not limited to, capric acid, lauric acid, and palmitic acid. Most preferably used as the carboxylic acid are higher fatty acids such as rosin acids, tall oil, and their derivatives, most preferably a C₂₁ dicarboxylic acid, DIACID 1550 sold by Westvaco. Other useful derivatives include partial esters of maleated tall oil fatty acid.

The amine used to form the amine salt of a fatty acid or derivative thereof can be any primary, secondary, or tertiary aliphatic amine. Examples include alkylamines, for instance methylamine, ethylamine, propylamine, and butylamine; alkanolamines, for instance as monoethanolamine, diethanolamine, and triethanolamine; morpholine; and cyclohexylamine. Preferably, the amine is triethanolamine, or N,N-diethylethanolamine, dimethylamine, 1,2-diaminoethane, diaminopropane, 7 ethanolamine, 2-methyl-2-amino-1-propanol, 5-aminopentanol, methoxypropylamine.

The amount of carboxylic acid and amine used to form the amine carboxylates can vary over wide ratios, but the amount typically used is such that the ratio of carboxyl groups of the carboxylic acid to amino groups of the amine is from 4:1 to 1:4, preferably about 2:1 to 1:2, most preferably about 1:1.

Preferably used as the salt of the non-polymeric aromatic acid are the alkali metal salts of benzoic acid. The amount of salt of the non polymeric aromatic acid used is from 1:5 to 5:1, parts by weight, 0.5:1 to 3:1 parts by weight based upon the total weight of the amine salt used, most preferably from 1:1 to 2:1.

An optional component of the barrier coating is a nonionic or anionic surfactant having hydrophilic-lipophilic balance (HLB) of 1-20. Preferably the surfactant is a polyoxyethylene-polyoxypropylene nonionic surfactant, having an average molecular weight of about 1000 to 10,000, preferably from 3000 to 5000, and a hydrophobe to hydrophile ratio of about 1:1 to 10:1, preferably from 3:1 to 10:1. The amount of nonionic surfactant use is from 1:30 to 2:1, preferably from 1:6 to 1:8, based upon the total weight of the amine salt used. Other useful surfactants include linear alcohol ethoxylates, for example, one with 12 to 15 carbon atoms and 9 moles of ethoxylation; and alkali metal salts of fatty acids, for example, oleic acid.

The amount of the various components in the barrier coating are within the following ranges: component (a) is typically used in an amount of from 5 to 30 parts by weight based upon the amount of barrier coating, preferably 10 to 20 parts by weight, and most preferably 15 to 20 parts by weight; component (b) is typically used in an amount of from 10 to 40 parts by weight based upon the amount of barrier coating, preferably 20 to 40 parts by weight, and most preferably 20 to 30 parts by weight; component (c) is typically used in an amount of from 1 to 10 parts by weight based upon the amount of barrier coating, preferably 1 to 5 parts by weight, and most preferably 2 to 3 parts by weight; and the amount of water typically used in the barrier coating is from 40 to 85 parts by weight based upon the amount of barrier coating, preferably 40 to 60 parts by weight, and most preferably 50 to 60 parts by weight

The barrier coating is most conveniently formulated as an aqueous solution of about 30 to 50 percent solids with a pH of about 7.0 to 8.0, preferably about 7.5.

### DEFINITIONS AND ABBREVIATIONS

TEA=triethanolamine.
DIACID=a C₂₁ diacid sold by WESTVACO as DIACID 1550.
PP=PLURONIC® Polyol L101, a polyoxypropylene-polyoxyethylene copolymer nonionic surfactant sold by BASF Corporation having an HLB value of 1, and an average molecular weight of about 3800, and hydrophobic and hydrophilic segments where the weight ration of hydrophobe to hydrophile is about 9 to 1.
SALT=salt of DIACID and TEA.
SBEN=sodium benzoate

### EXAMPLES

### Example 1

A barrier coating was formulated by mixing the components set forth in Table I. The components were added by continuous mixing in the following order: water, TEA, DIACID, SBEN, and PP. The pH of the barrier coating was about 7.5.

TABLE I
BARRIER COATING FORMULATION

| | |
|---|---|
| Deionized water | 56.6 parts |
| TEA salt of DIACID | 15.2 parts |
| Sodium benzoate (SBEN) | 26.2 parts |
| PLURONIC Polyol L101 (PP) | 2.0 parts |
| Total | 100.0 parts |

Mild carbon steel panels were coated with the barrier coating of Example 1 to a thickness of 0.81 mils and 2.88 mils using a RDS Coating Rod. The panels were dried for two hours. Then one part of Portland cement mixed with 0.5 parts of water and applied to the treated steel panel and an untreated panel.

The cement was left to dry overnight. Then the panels were then sprayed with water from an aspirator bottle. The cement was easily removed from the treated panel, down to bare metal. On the other hand, the cement remained adhered to the untreated panel. Essentially none of the cement was removed from the treated panel after washing with water.

We claim:

1. A process for coating a metal surface, wherein said process comprises contacting the metal surface with a barrier coating comprising:
(a) an amine salt of a fatty acid or an amine salt of a derivative of a fatty acid,
(b) a salt of a non polymeric aromatic acid, and
(c) water.

2. The process of claim 1 wherein the metal surface coated is substantially free of residues.

3. The process of claim 2 wherein component (b) is an alkali metal benzoate.

4. The process of claim 3 wherein component (a) is the triethanolamine salt of a C₂₁ diacid.

5. The process of claim 4 wherein the barrier coating is allowed to dry.

6. The process claim 5 wherein the metal is carbon steel.

7. The process of claim 7 wherein the metal surface is the surface of a container or a cargo vessel.

8. The process of claims 1, 2, 3, 4, 5, 6, or 7 wherein the barrier coating also comprises a surfactant.

9. The process of claim 8 wherein the barrier coating contains from 5 to 30 parts by weight of an amine salt of a fatty acid, (b) 10 to 40 parts by weight of a salt of a non polymeric aromatic acid, (c) from 1 to 10 parts by weight of a surfactant, and from 40 to 85 parts by weight of water, where said parts by weight are based upon 100 parts by weight of barrier coating.

10. A process for removing deposits on a metal surface comprising:
A. contacting the metal surface with a barrier coating comprising:
(1) an amine salt of a fatty acid or an amine salt of a derivative of a fatty acid,
(2) a salt of a non polymeric aromatic acid, and
(3) water; and
B. contacting the coated metal surface with water.

11. The process of claim 10 wherein the metal surface coated is substantially free of residues.

12. The process of claim 11 wherein component (2) is an alkali metal benzoate.

13. The process of claim 12 wherein component (1) is the triethanolamine salt of a C₂₁ diacid.

14. The process of claim 13 wherein the barrier coating is allowed to dry.

15. The process claim 14 wherein the metal is carbon steel.

16. The process of claim 15 wherein the metal surface is the surface of a container or a cargo vessel.

17. The process of claims 10, 11, 12, 13, 14, 15, or 16 wherein the barrier coating also comprises a surfactant.

18. The process of claim 8 wherein the barrier coating contains from 5 to 30 parts by weight of an amine salt of a fatty acid, (b) 10 to 40 parts by weight of a salt of a non polymeric aromatic acid, (c) from 1 to 10 parts by weight of a surfactant, and from 40 to 85 parts by weight of water, where said parts by weight are based upon 100 parts by weight of barrier coating.

19. The process of claim 18 wherein water is sprayed onto the deposit-containing metal surface in an amount sufficient to remove all or substantially all of the deposits from the metal surface.
